(19) United States
(12) Patent Application Publication
(10) Pub. No.: US 2014/0253569 A1
(43) Pub. Date: Sep. 11, 2014

(54) INFORMATION PROCESSING DEVICE, INFORMATION PROCESSING METHOD, AND RECORDING MEDIUM

(71) Applicant: CASIO COMPUTER CO., LTD., Tokyo (JP)

(72) Inventor: Shohei SAKAMOTO, Tokyo (JP)

(73) Assignee: CASIO COMPUTER CO., LTD., Tokyo (JP)

(21) Appl. No.: 14/105,560

(22) Filed: Dec. 13, 2013

(30) Foreign Application Priority Data
Mar. 8, 2013 (JP) 2013-046382

(51) Int. Cl. G06T 1/60

(52) U.S. Cl. CPC G06T 1/60
USPC 345/530

(57) ABSTRACT

A withdrawer withdrawing an image presenting the memory contents of a volatile storage to a nonvolatile storage at the time of power shutdown; a withdrawal controller controlling the withdrawer to withdraw an image containing only data regarding the programs fulfilling a given withdrawal condition among multiple running programs to the nonvolatile storage if the image contains data regarding the multiple programs; and a restorer restoring the operation state of the device to the operation state at the time of last power shutdown based on the image at the time of resupply of power if the image withdrawn by the withdrawer at the time of last power shutdown is present in the nonvolatile storage.

### CROSS-REFERENCE TO RELATED APPLICATION

This application claims the benefit of Japanese Patent Application No. 2013-046382, filed on Mar. 8, 2013, the entire disclosure of which is incorporated by reference herein.

### FIELD

This application relates generally to a hibernation technique for information processing devices.

### BACKGROUND

One of the prior art high speed start-up techniques for information processing devices is hibernation in which the data held in the main storage, which is volatile storage means such as a DRAM (dynamic random access memory), are stored (withdrawn) in an auxiliary storage, which is nonvolatile storage means such as a HDD (hard disk drive), as an image presenting the memory contents as they are at the time of power shutdown, and at the time of next power supply, the image is read back to the main storage and used so as to speed up the start-up processing.

For example, Patent Literature of Unexamined Japanese Patent Application Kokai Publication No. H10-333997 describes a technique of organizing idle regions and erasing erasable regions in the main storage and storing in the auxiliary storage only the data in the regions other than the organized idle regions or erasable regions at the time of power shutdown. With this technique, the volume of data stored in the auxiliary storage, namely the volume of data read back to the main storage at the time of next power supply can be reduced, whereby the next start-up processing can be sped up.

However, even with the memory being organized at the time of power shutdown as described above, for example, if multiple application program are running at the time of power shutdown, a large volume of data has to be stored in the auxiliary storage depending on the number of running application programs. Then, a problem is that the next start-up processing requires more time as the number of running application programs is increased.

### SUMMARY

The present invention, comprising: a withdrawer withdrawing an image presenting the memory contents of a volatile storage to a nonvolatile storage at the time of power shutdown; a withdrawal controller controlling the withdrawer to withdraw an image containing only data regarding the programs fulfilling a given withdrawal condition among multiple running programs to the nonvolatile storage if the image contains data regarding the multiple programs; and a restorer restoring the operation state of the device to the operation state at the time of last power shutdown based on the image at the time of resupply of power if the image withdrawn by the withdrawer at the time of last power shutdown is present in the nonvolatile storage.

### BRIEF DESCRIPTION OF THE DRAWINGS

A more complete understanding of this application can be obtained when the following detailed description is considered in conjunction with the following drawings, in which:

FIG. 1 is a block diagram showing the core parts of the information processing device according to the present invention and shared by the embodiments;

FIG. 2 is a flowchart showing the procedure regarding the hibernation and shared by the embodiments;

FIG. 3 is a flowchart showing the details of the image saving procedure of Embodiment 1; and

FIG. 4 is a flowchart showing the details of the image saving procedure of Embodiment 2.

### DETAILED DESCRIPTION

### Embodiment 1

Embodiments of the present invention will be described hereafter.

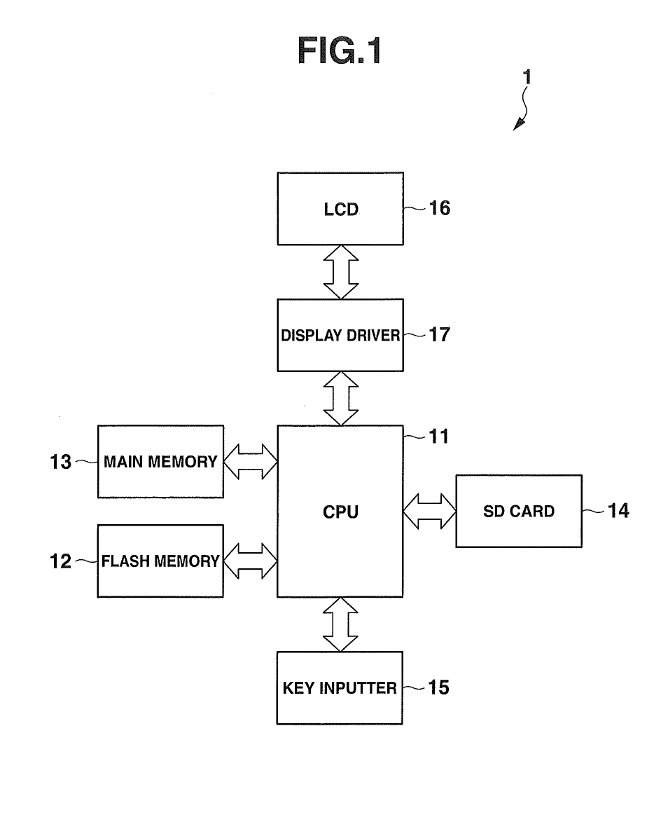

FIG. 1 is a block diagram showing the core parts of an information processing device 1 and applicable to Embodiment 1 and Embodiment 2, which will be described later, of the present invention. The information processing device 1 is any electronic device such as a cell-phone, smart phone, PDA (personal digital assistant), and digital camera.

The information processing device 1 comprises a CPU 11 (central processing unit) 11 controlling the entire device, a flash memory 12, a main memory 13, an SD card 14, a key inputter 15, an LCD (liquid crystal display) 16, and a display driver 17.

The flash memory 12 is a nonvolatile recording medium comprising, for example, a NAND flash memory. The flash memory 12 holds various programs the CPU 11 executes in controlling the information processing device 1. The various programs include a boot loader, an OS (operating system), and multiple application programs.

The flash memory 12 further contains priority levels set for the multiple application programs and priority level information presenting a threshold of the priority levels. The priority level information is information the CPU 11 uses in the hibernation procedure described later.

In this embodiment, the priority levels set for the application programs are fixed values predetermined according to the anticipated frequency of use. In other words, the application programs of which the anticipated frequency of use is higher are given higher priority levels than the application programs of which the anticipated frequency of use is relatively lower. Furthermore, the threshold of the priority levels is also a fixed value predetermined according to the frequency of use.

The main memory 13 is a randomly accessible volatile recording medium comprising, for example, a DRAM. The main memory 13 is used as the working memory as the CPU 11 executes the programs. In other words, the main memory 13 stores the programs the CPU 11 reads from the flash memory 12 and various data created during the control.

The SD card 14 is a nonvolatile recording medium comprising, for example, a NAND flash memory. The SD card 14 is a card-type memory detachably mounted in a slot provided on the not-shown body of the information processing device 1 and connected to the CPU 11 via an input/output interface.

The SD card 14 holds various user data created by the user of the information processing device 1. The various user data are data according, for example, to specific functions of the information processing device 1, namely to the application programs held in the flash memory 12. Examples of the various user data include telephone book data, transmitted/received email data, still image data, video image data, schedule data, documents data, and music data.

Furthermore, the SD card 14 also stores a system image (simply an image, hereafter) that is data presenting the memory contents of the main memory 13 when the CPU 11 executes an image saving procedure described later.

The key inputter 15 comprises various operation buttons including a power key and enters the operation commands from the user to the information processing device 1 as electric signals.

The LCD 16 is a display device having a color liquid crystal panel and outputs characters and images.

The display driver 17 creates graphic data such as characters and images to display on the LCD 16 according to instruction from the CPU 11 and drives the LCD 16.

The operation regarding the hibernation function of the information processing device 1 having the above configuration will be described hereafter.

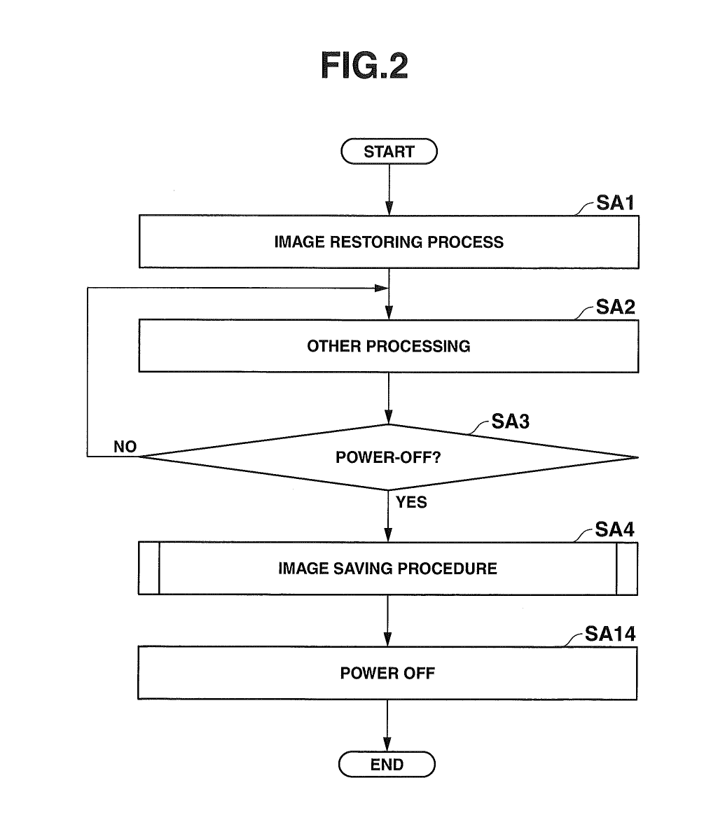

FIG. 2 is a flowchart showing a procedure mainly regarding the hibernation and executed by the CPU 11 according to programs held in the flash memory 12. This flowchart shows the processing after the user turns on the power.

The explanation will be made hereafter. Starting to operate upon power-on, the CPU 11 first executes an image restoring process (Step SA1).

The image restoring process is a process to read the aforementioned image from the SD card 14 and write the image in the main memory 13 as in the general process upon power-on in the prior art hibernation. With this process, the information processing device 1 is restored to its operation state at the time of last power-off.

Subsequently, the CPU 11 starts other processing (Step SA2). For example, if any application program (simply a program, hereafter) was running at the time of last power-off, the CPU 11 immediately resumes the processing according to the program.

From then on, the CPU 11 constantly determines whether, for example, a power-off request is made by the user in parallel to the above other processing. In no power-off request is made (Step SA3; NO), the CPU 11 continues the above other processing.

On the other hand, if a power-off request is made at any time (Step SA3; YES), the CPU 11 immediately executes an image saving procedure (Step SA4).

In the image saving procedure, the details of will be described later, the CPU 11 saves (withdraws) to the SD card 14 an image presenting the memory contents of the main memory 13 at the time of power-off and to be used in the image restoring process in the Step SA1 at the time of next power-on operation.

Then, after the image saving procedure ends, the CPU 11 turns off the power (Step SA14) and ends the procedure.

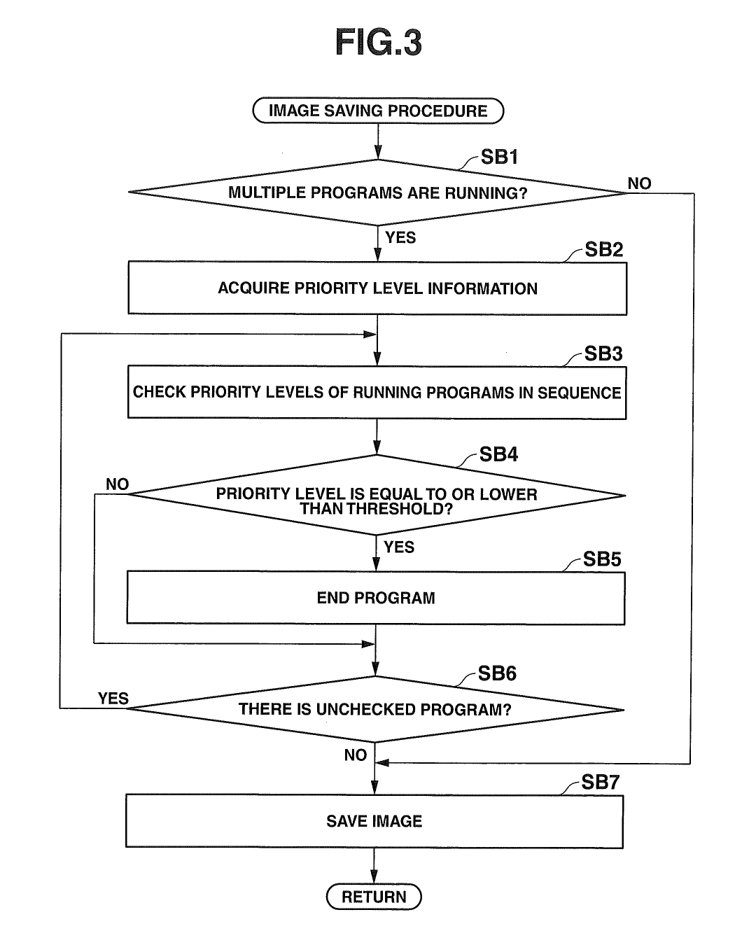

FIG. 3 is a flowchart showing the details of the aforementioned image saving procedure in the Step SA4.

In the image saving procedure, the CPU 11 checks whether currently (at the time of a power-off request being made) multiple programs are running (Step SB 1).

Then, if multiple programs are not running (Step SB 1; NO), the CPU 11 immediately saves the image of the main memory 13 in the SD card 14 (Step SB7), and returns to the above-described procedure in FIG. 2. In other words, the CPU 11 executes the processing generally executed at the time of power-off in the prior art hibernation, and ends the image saving procedure.

On the other hand, if multiple programs are running (Step SB 1; YES), the CPU 11 acquires the aforementioned priority level information from the flash memory 12 (Step SB2) and checks the priority levels of the running programs presented by the priority level information in sequence (Step SB3).

Then, if the checked priority level of a program is equal to or less than a threshold (Step SB4; YES), the CPU 11 ends the program (Step SB5) and checks whether there is any unchecked program (Step SB6).

On the other hand, if the checked priority level of a program is not equal to or less than the threshold (Step SB4; NO), the CPU 11 keeps the program running and checks whether there is any unchecked program (Step SB6)

Then, if there is any unchecked program (Step SB6; YES), the CPU 11 returns to the processing of the Step SB3 and repeats the processing of the Step SB3 to SB6 on the next program. Consequently, the CPU 11 ends all programs of which the priority level is equal to or less than the threshold among the multiple running programs.

Subsequently, the CPU 11 saves in the SD card 14 an image containing only the data regarding one or multiple programs of which the priority level exceeds the threshold as an image presenting the memory contents of the main memory 13 at the time, namely the data regarding the running programs (Step SB7). Then, the CPU 11 ends the image saving procedure, and returns to the above-described procedure in FIG. 2.

As described above, in this embodiment, the image saved (withdrawn) to the SD card 14 in the image saving procedure contains only the data regarding one or multiple programs of which the priority level exceeds the threshold.

Therefore, the data volume of the image to be saved (withdrawn) to the SD card 14, namely the volume of data to be rewritten in the main memory 13 from the SD card 14 in the image restoring process at the time of next power-on can be reduced compared with the prior art data volume containing the data regarding all programs running at the time of power-off.

Then, in this embodiment, even if multiple programs are running at the time of power-off, the time required for the next start-up processing is not unnecessarily prolonged. Consequently, the next start-up processing upon power supply can be sped up regardless of the operation state at the time of power-off. At the same time, the processing up to actual power-off since a power-off request is made can be sped up regardless of the operation state at the time of power-off.

Furthermore, in the above-described image saving procedure, the programs that are kept running until the image of the main memory 13 is saved in the SD card 14 are the programs having a priority level exceeding a threshold, namely the programs ranked in priority equal to or higher than a given rank. Consequently, the volume of data to be rewritten in the main memory 13 from the SD card 14 can reasonably be reduced.

Furthermore, provided that the priority levels of programs and a threshold of the priority levels are predetermined according to the anticipated frequency of use of the programs as in this embodiment, the user can immediately use a highly frequently used program after the next start-up as long as the program was running at the time of power-off. Therefore, the next start-up processing can constantly be sped up regardless of the operation state at the time of power-off while maintaining a certain level of convenience of the hibernation.

### Embodiment 2

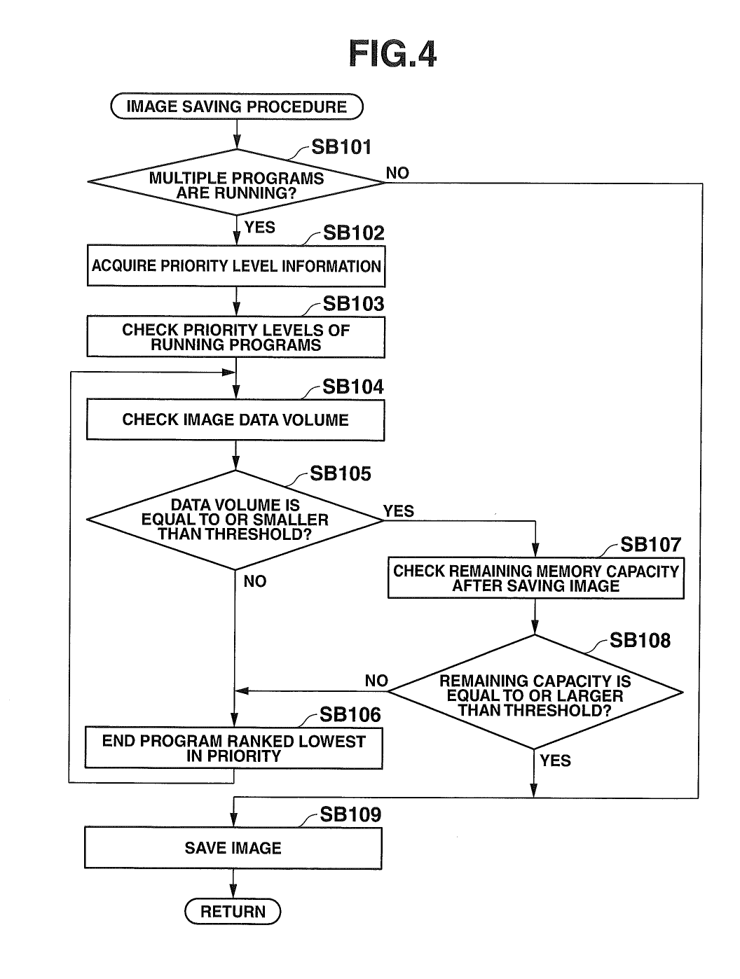

Embodiment 2 of the present invention will be described hereafter. In this embodiment, with the configuration shown in FIG. 1, the priority level information stored in the flash memory 12 includes only the above-described priority levels set for multiple application programs and when the CPU 11 executes the procedure shown in FIG. 2 according to the programs held in the flash memory 12, the CPU 11 executes, unlike Embodiment 1, an image saving procedure shown in FIG. 4 in the image saving procedure of the Step SA4.

The details of the image saving procedure executed by the CPU 11 in this embodiment will be described hereafter according to FIG. 4.

Also in this embodiment, upon the image saving procedure, the CPU 11 first checks whether currently (at the time of a power-off request being made) multiple programs are running (Step SB101).

Then, if multiple programs are not running (Step SB 101; NO), the CPU 11 immediately saves the image of the main memory 13 in the SD card 14 (Step SB109), and returns to the above-described procedure in FIG. 2.

On the other hand, if multiple programs are running (Step SB 101; YES), the CPU 11 first acquires the above-described priority level information from the flash memory 12 (Step SB 102) and checks the priority levels of the running programs presented by the priority level information (Step SB 103).

Then, the CPU 11 first checks the total data volume of the image of the main memory 13 to withdraw to the SD card 14 in the current operation state (Step SB 104).

Here, if the data volume is not equal to or smaller than a predetermined threshold, namely exceeds a given volume (Step SB 105; NO), the CPU 11 ends the program having the lower priority level among the multiple programs currently running (Step SB 106), returns to the processing of the Step SB 104, and checks the total data volume of the image of the main memory 13 once again.

From then on, the CPU 11 repeats the processing of the Steps SB 104 to SB 106 while the total data volume of the image of the main memory 13 exceeds the threshold (Step SB 105; NO). In other words, the CPU 11 ends one or multiple running programs one by one in the order of priority level.

Then, after the total data volume of the image of the main memory 13 becomes equal to or smaller than the threshold as a result of ending the programs as described above (Step SB 105; Yes), the CPU 11 subtracts the total data volume of the image of the main memory 13 from the currently remaining memory capacity of the SD card 14 to check the remaining memory capacity of the SD card 14 after the entire image of the main memory 13 is saved (Step SB 107). Here, the processing of the Step SB 107 is executed even if the total data volume of the image is equal to or smaller than the threshold from the beginning.

Then, if the remaining memory capacity of the SD card 14 is not equal to or larger than a predetermined threshold (Step SB 108; NO), the CPU 11 ends the program having the lowest priority level among the multiple programs currently running (Step SB 106), and repeats the processing of the Step SB 104 and subsequent steps.

Subsequently, at the time when the total data volume of the image of the main memory 13 becomes equal to or smaller than the threshold and the remaining memory capacity of the SD card 14 after the image is saved becomes equal to or larger than the threshold (Step SB 108; YES), the CPU 11 saves in the SD card 14 an image containing only the data regarding one or multiple programs ranked equal to or higher than a given rank that changes according to the usage of the main memory 13 at the time of power-off as an image presenting the memory contents of the main memory 13, namely data regarding the running programs at the time (Step SB 109). Then, the CPU 11 ends the image saving procedure, and returns to the above-described procedure in FIG. 2.

As described above, in this embodiment, the image saved (withdrawn) to the SD card 14 in the image saving procedure contains only the data regarding one or more programs ranked equal to or higher than a given rank that changes according to the usage of the main memory 13.

Therefore, the data volume of the image to be saved (withdrawn) to the SD card 14, namely the volume of data to be rewritten in the main memory 13 from the SD card 14 in the image restoring process at the time of next power-on can be reduced compared with the prior art data volume containing the data regarding all programs running at the time of power-off.

Therefore, also in this embodiment, as described in Embodiment 1, the next start-up processing upon power supply can constantly be sped up regardless of the operation state at the time of power-off. At the same time, the processing up to actual power-off since a power-off request is made can also constantly be sped up regardless of the operation state at the time of power-off.

Furthermore, in this embodiment, the programs that are kept running until the image of the main memory 13 is saved in the SD card 14 are the programs ranked equal to or higher than a given rank that changes according to the usage of the main storage 13 at the time of power-off. Then, also in this embodiment, the volume of data to be rewritten in the main storage 13 from the SD card 14 can reasonably be reduced.

Furthermore, with the priority levels of the programs being predetermined according to the anticipated frequency of use of the programs, as in Embodiment 1, the next start-up processing can constantly be sped up regardless of the operation state at the time of power-off while maintaining a certain level of convenience of the hibernation.

In the above-described image saving procedures of Embodiments 1 and 2, the programs not fulfilling the withdrawal condition, namely the programs ranked in priority equal to or lower than a given rank among multiple running programs are ended before the image of the main memory 13 is saved in the SD card 14. However, the image saving procedure can be as follows.

For example, in the image saving procedure, it is possible not to end the programs ranked in priority equal to or lower than a given rank and not fulfilling the withdrawal condition prior to saving an image in the SD card 14, and alternatively to create a withdrawal image containing only the other programs ranked higher in priority and fulfilling the withdrawal condition, and withdraw the created image to the SD card 14.

Furthermore, in Embodiments 1 and 2, the priority levels set for the programs are fixed values predetermined according to the anticipated frequency of use. However, in implementation of the present invention, it is possible to make the priority levels of the programs changeable by the user as necessary. This also applies to the threshold of the priority levels used in Embodiment 1.

Furthermore, the priority levels of the programs can be set by the CPU 11 as appropriate in accordance with given criteria. For example, each time the user activates any program after power-on, or each time the CPU 11 automatically starts a resident program, the CPU 11 counts the start number. Then, the CPU 11 sets higher priority levels for the programs (ranks higher the programs) that are started later.

In such a case, as for a program that was used for a certain length of time immediately before the last power-off and that is highly possibly to be used immediately after the next start-up, the user can use the program immediately after the next-startup. Therefore, as in Embodiments 1 and 2, the next start-up processing can constantly be sped up regardless of the operation state at the time of power-off while maintaining a given level of convenience of the hibernation.

Furthermore, the image saving procedures in Embodiments 1 and 2, the programs that are kept running until the image of the main memory 13 is saved in the SD card 14, namely the programs fulfilling the withdrawal condition are the programs ranked higher in priority among multiple programs. Such programs can be, for example, one or multiple specific programs preset by the user.

Also in such a case, the next start-up processing upon power supply can constantly be sped up regardless of the operation state at the time of power-off. At the same time, the processing up to actual power-off since a power-off request is made can constantly be sped up regardless of the operation state at the time of power-off. Furthermore, the volume of data to be rewritten in the main memory 13 from the SD card 14 can reasonably be reduced.

Several embodiments of the present invention and their modified embodiments are described above. Those embodiments can be modified as appropriate within the range of the efficacy of the present invention being obtainable. Such modified embodiments fall within the scope of the invention described in the scope of claims and the invention equivalent to that invention.

Having described and illustrated the principles of this application by reference to one or more preferred embodiments, it should be apparent that the preferred embodiments may be modified in arrangement and detail without departing from the principles disclosed herein and that it is intended that the application be construed as including all such modifications and variations insofar as they come within the spirit and scope of the subject matter disclosed herein.

What is claimed is:

1. An information processing device, comprising:
a withdrawer withdrawing an image representing the memory contents of a volatile storage to a nonvolatile storage at the time of power shutdown;
a withdrawal controller controlling the withdrawer to withdraw an image containing only data regarding the programs fulfilling a given withdrawal condition among multiple running programs to the nonvolatile storage if the image contains data regarding the multiple programs; and
a restorer restoring the operation state of the device to the operation state at the time of last power shutdown based on the image at the time of resupply of power if the image withdrawn by the withdrawer at the time of last power shutdown is present in the nonvolatile storage.

2. The information processing device according to claim 1 wherein
the withdrawal controller uses the withdrawal condition of being ranked in priority equal to or higher than a given rank and controls the withdrawer to withdraw an image containing only data regarding the programs fulfilling the withdrawal condition in the nonvolatile storage.

3. The information processing device according to claim 2 wherein
the withdrawal controller ranks the multiple programs so that the programs that have started at later times during power supply are ranked higher in priority, uses the withdrawal condition of the rank in priority being equal to or higher than a given rank, and controls the withdrawer to withdraw an image containing only data regarding the programs fulfilling the withdrawal condition to the nonvolatile storage.

4. The information processing device according to claim 2 wherein
the withdrawal controller uses the withdrawal condition of being ranked in priority equal to or higher than a given rank that changes according to the usage of the volatile storage and withdraws an image containing only data regarding the programs fulfilling the withdrawal condition to the nonvolatile storage.

5. The information processing device according to claim 1 wherein
the withdrawal controller uses the withdrawal condition of being a program specified by the user in advance and controls the withdrawer to withdraw an image containing only data regarding the programs fulfilling the withdrawal condition to the nonvolatile storage.

6. The information processing device according to claim 1, comprising:
an ender ending a program not fulfilling the given withdrawal condition among multiple running programs prior to the image withdrawal operation by the withdrawer if the image contains data regarding the multiple programs at the time of power shutdown.

7. An information processing method comprising a step of withdrawing an image representing the memory contents of a volatile storage to a nonvolatile storage at the time of power shutdown, comprising:
a step of withdrawing an image containing only data regarding the programs fulfilling a predetermined withdrawal condition among multiple programs to the nonvolatile storage as the image if the image contains data regarding the multiple programs; and
a step of restoring the operation state of the device to the operation state at the time of last power shutdown based on the image at the time of resupply of power if the image withdrawn at the time of last power shutdown is present in the nonvolatile storage.

8. A recording medium having recorded programs that allow a computer to function as:
a withdrawer withdrawing an image representing the memory contents of a volatile storage to a nonvolatile storage at the time of power shutdown;
a withdrawal controller controlling the withdrawer to withdraw an image containing only data regarding the programs fulfilling a predetermined withdrawal condition among multiple programs to the nonvolatile storage if the image contains data regarding the multiple programs; and
a restorer restoring the operation state of the device to the operation state at the time of last power shutdown based on the image at the time of resupply of power if the image withdrawn by the withdrawer at the time of last power shutdown is present in the nonvolatile storage.
